(19) United States
(12) Patent Application Publication
(10) Pub. No.: US 2013/0159685 A1
(43) Pub. Date: Jun. 20, 2013

(54) CONTROL FLOW-BASED APPROACH IN IMPLEMENTING EXCEPTION HANDLING ON A GRAPHICS PROCESSING UNIT

(71) Applicants: Dz-ching Ju, Saratoga, CA (US); Norman Rubin, Cambridge, MA (US); Gang Chen, Southborough, MA (US)

(72) Inventors: Dz-ching Ju, Saratoga, CA (US); Norman Rubin, Cambridge, MA (US); Gang Chen, Southborough, MA (US)

(73) Assignee: ADVANCED MICRO DEVICES, INC., Sunnyvale, CA (US)

(21) Appl. No.: 13/326,587

(22) Filed: Dec. 15, 2011

(51) Int. Cl. G06F 9/38

(52) U.S. Cl. 712/244; 712/E09.06

(57) ABSTRACT

A function in source code is processed by a compiler for execution on a graphics processing unit, wherein the function includes an exception handling structure. An exception raising block is converted into a first control flow and an exception handler block is converted into a second control flow. The first control flow includes setting an exception raised indicator and finding an exception handler to process the raised exception. The exception raised indicator remains set until an appropriate exception handler is found. The second control flow includes clearing the exception raised indicator and processing the exception.

### FIELD OF THE INVENTION

The present invention is generally directed to implementing exception handling in computer program code, and in particular, to implementing exception handling in computer program code run on a graphics processing unit.

### BACKGROUND

The problem that is addressed herein is to support the exception handling feature of programming languages for graphics processing unit (GPU) computing applications on GPU architectures. Many programming languages, such as C++, Java, C#, Python, Ada, Ruby, and more, support exception handling (EH), which provides a way to react to exceptional circumstances (like runtime errors) in a program by transferring control and information from the exception point to an exception handler. The purpose of EH is to cleanly separate the error handling from the rest of the program logic. The C++ EH feature is used herein to discuss the issues and to illustrate the proposed techniques, but the discussions and techniques are also applicable to the EH support in other languages.

The current C++ EH mechanism is defined with respect to single thread execution. There are certain extensions beyond the current C++ language standard to propagate exceptions across multiple threads. A number of such extensions and how they may be handled on the Fusion System Architecture (FSA), which is an architecture for accelerated processing units (APUs), which combine features of a central processing unit (CPU) and a GPU on a single die and as manufactured by Advanced Micro Devices, Inc., have been previously described.

C++ EH primarily consists of the try, catch, throw, and re-throw constructs. A try block encloses a portion of code under exception inspection. An exception is thrown by using a throw clause from inside a try block. Exception handlers are declared with a catch clause, which is placed immediately after the corresponding try block. If no exception is thrown, the program execution continues normally and all handlers are ignored. Matching a thrown exception object to an exception handler is based on the type specified in the catch clause. If an exception is thrown but is not caught by any immediate catch clause, the exception is propagated to the enclosing try blocks to check against their respective catch clauses. If an exception handler is not located within the current function, the current function returns and the call stack is unwound to the caller to search for a proper exception handler. This process continues until an exception handler is found or the execution is terminated when the search exhausts all call stack frames.

The following is a simple C++ EH example.

int foo ( ) {

int x = 30;
try { throw 20; }
catch (float e) // int e?
{ x = 40; }
return x;

}
int main ( ) {

int x = 0;
try { x = foo( ); }
catch (int e)
{ x = 10; }
printf(“%d\n”, x);

}

Because the function foo( ) throws an exception object with a value of 20, which is an integer, the exception is not caught within the function foo( ) because the exception handler has a float type, and the function foo( ) immediately returns and propagates the exception to the caller. The exception is caught by the handler “catch (int e)” in the function main( ), and the output of the program is 10. If the exception handler in the function foo( ) were “catch (int e)” as noted in the comment, the thrown exception would have been caught and handled by the handler in the function foo( ) The function foo( ) would have returned normally without an exception, and the output would have been 40.

While the C++ language including the EH feature has been fully supported on CPUs for decades, the differences between CPU and GPU architectures as well as the differences in their associated tool chains present new challenges to support some existing C++ language features on a GPU.

Because GPUs use the SIMD (single instruction, multiple data) execution model (e.g., a vector instruction) to support data parallelism (each thread executing with one piece of data), a set of work-items share the same instruction pointer and are executed in lock-steps. But there are times when these work-items want to execute different code paths due to the differences in the data processed by the respective work-items.

Predication is one mechanism to handle such thread divergence, where the predicated-off work-items still execute the same instruction stream along with the predicated-on work-items, except that they do not write any results to affect the architectural states. But predication usually handles only a limited set of control flow divergence found in regular control flow structures. With divergence in more complex control flows, the GPU architecture may serialize the execution of diverged work-items through a pair of specially marked branch and join instructions. Because compilers typically generate codes one function at a time, it is infeasible to place the branch and join instructions in different functions in such cases. This practically limits the support of thread divergence to within a function scope. If the execution of work-items may diverge across a function boundary, this restriction would require the functions to join at the function granularity and then diverge again immediately after function return.

The GPU tool chains are noticeably different from the CPU tool chains in that because the GPU architectures evolve quickly and have a proprietary instruction set architecture (ISA), GPU vendors typically provide an abstraction intermediate representation (as opposed to an actual ISA) to software, where this abstract intermediate representation is stable over multiple generations of GPU architectures.

In the case of FSA, this layer is called FSAIL (FSA Intermediate Language). Because of the gap between FSAIL and the native GPU ISA, a layer of software is required to dynamically translate FSAIL instructions to the native GPU ISA, and this software is called the FSA just-in-time (JIT) compiler. The compiler which generates the FSAIL instructions has a similar role to the typical CPU compiler, and in contrast to the JIT compiler, this compiler is a high-level compiler. Because the JIT compiler translates FSAIL instructions and possibly re-orders the produced native GPU instructions, the FSAIL instruction order produced by the high-level compiler may not be preserved in the JIT-produced native instruction sequence. This potentially inconsistent order presents a challenge if a high-level compiler intends to communicate certain information to the runtime system by relying on the FSAIL instruction order, which is part of the design in a “zero-cost” EH implementation on CPUs (discussed below).

EH is considered a high-productivity language feature instead of a performance feature. Exceptions are expected to occur infrequently and hence the performance of handling exceptions is usually less of a concern. One of the key design issues in implementing EH is to minimize any adverse performance impact when EH constructs are present, but no exceptions are actually thrown, which is expected a common case. Unless a compiler is told otherwise, C++ programs by default have to assume that any function call may throw an exception.

The EH features in C++ and other programming languages have been well-supported on CPUs. Some initial EH implementations simply mapped EH constructs back to setjmp/longjmp instructions, which had been an error handling mechanism predating the general EH language feature. There are a number of issues with the setjmp/longjmp approach. First, it imposes a fair amount of overhead to save and set up information on regular execution paths to be ready to handle exceptions even if no exceptions are eventually thrown. Second, the presence of setjmp/longjmp instructions often require shutting down many subsequent compiler optimizations to preserve the states that need to be saved and restored. In addition, setjmp/longjmp instructions may transfer control flows across a function boundary. While this is not an issue on a CPU, it does not work well with the current GPU data parallel architectures as mentioned above.

In one implementation, the Itanium application binary interface (ABI) Exception Handling Specification defines a methodology for providing outlying data in the form of exception tables, without inlining the testing of exception occurrence to conditionally branch to exception handling code in the flow of an application's main algorithm. Thus, the specification is said to add “zero-cost” to the normal execution of an application.

In the “zero-cost” EH implementation, a C++ compiler generates exception tables stored in data sections of object files and retrieved by the C++EH runtime library when an exception is thrown during program execution. The runtime system first attempts to find an exception frame corresponding to the function where the exception was thrown. The exception frame contains a reference to an exception table describing how to process the exception. If the exception needs to be forwarded to a prior activation (i.e., a caller), the exception frame contains information about how to unwind the current activation and restore the state of the prior activation. An exception handling personality is defined by way of a personality function (e.g., _gxx_personality_v0 in C++), which receives the context of the exception, an exception structure containing the exception object type and value, and a reference to the exception table for the current function.

An exception table is organized as a series of code ranges defining what to do if an exception occurs in that range. Typically, the information associated with a range defines which types of exception objects (using C++ type information) that are handled in that range, and an associated action that should take place. Actions typically pass control to a landing pad. A landing pad corresponds to the code found in the catch portion of a try/catch sequence. When execution resumes at a landing pad, it receives the exception structure and a selector corresponding to the type of exception thrown. The selector is then used to determine which catch clause should process the exception.

While the steps to identify exception handlers and handle exceptions are elaborative in the “zero-cost” EH implementation, the biggest advantage of this approach is that these costs are incurred only when exceptions occur. Normal execution paths, where no exceptions are thrown, have minimal performance impact. Another benefit is that this approach puts a fair amount of work, e.g., stack unwinding and exception frames, into the common ABI of a given architecture. This common support can be shared across the EH features often with slight variations among different programming languages and can reduce the amount of language-specific work. This also allows EH to work when mixing functions written in different languages in an application.

Applying the “zero-cost” EH implementation to a GPU encounters certain issues. First, the unwinding step could lead to threads divergent across a function boundary. This is related to a hardware limitation of GPUs, in that thread divergence on a GPU only works within a function boundary. But, for EH to work properly, it needs to be able to work across function boundaries (to be able to locate an exception handler for a thrown exception).

Second, the FSAIL instructions that are generated by high-level compilers are abstract instructions and may be subsequently re-ordered by the JIT compiler. Checking an exception-throwing instruction against the code ranges tracked in the exception tables generated by the high-level compilers may be problematic, because the re-ordered instructions may not be in the original code range as shown in the exception tables. In contrast, the instruction sequence generated by a CPU compiler is final and checking a given instruction against code ranges in exception tables is not an issue.

### SUMMARY

A method is described for processing a function in source code by a compiler for execution on a graphics processing unit, wherein the function includes an exception handling structure. The method includes converting an exception raising block into a first control flow and converting an exception handler block into a second control flow. The first control flow includes setting an exception raised indicator and finding an exception handler to process the raised exception. The second control flow includes clearing the exception raised indicator and processing the exception. The exception raised indicator remains set until an appropriate exception handler is found.

A system includes a processor and a compiler executed by the processor to perform operations. The operations performed by the compiler include converting an exception raising block into a first control flow and converting an exception handler block into a second control flow. The first control flow includes setting an exception raised indicator and finding an exception handler to process the raised exception. The second control flow includes clearing the exception raised indicator and processing the exception.

A computer-readable storage medium storing a set of instructions for execution by a computer to process a function in source code for execution on a graphics processing unit, wherein the function includes an exception handling structure. The set of instructions includes a first converting code segment for converting an exception raising block into a first control flow and a second converting code segment for converting an exception handler block into a second control flow. The first control flow includes setting an exception raised indicator and finding an exception handler to process the raised exception. The second control flow includes clearing the exception raised indicator and processing the exception.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more disclosed embodiments may be implemented;

FIG. 2 is a flowchart of a method for processing C++ code to implement exception handling on a GPU;

FIG. 3 is a flowchart of a method for processing a catch clause in a current try block;

FIG. 4 is a flowchart of a method for processing a throw clause or a function call in a current try block;

FIG. 5 is a flowchart of a method for processing a catch clause in an enclosing try block;

FIG. 6 is a flowchart of a method for processing a found handler flag in an enclosing try block;

FIG. 7 is a flowchart of a method for processing a found handler flag in a current try block; and

FIG. 8 is a flowchart of a method for processing a function located outside a try block.

### DETAILED DESCRIPTION

A function in source code is processed by a compiler for execution on a graphics processing unit, wherein the function includes an exception handling structure. An exception raising block is converted into a first control flow and an exception handler block is converted into a second control flow. The first control flow includes setting an exception raised indicator and finding an exception handler to process the raised exception. The exception raised indicator remains set until an appropriate exception handler is found. The second control flow includes clearing the exception raised indicator and processing the exception.

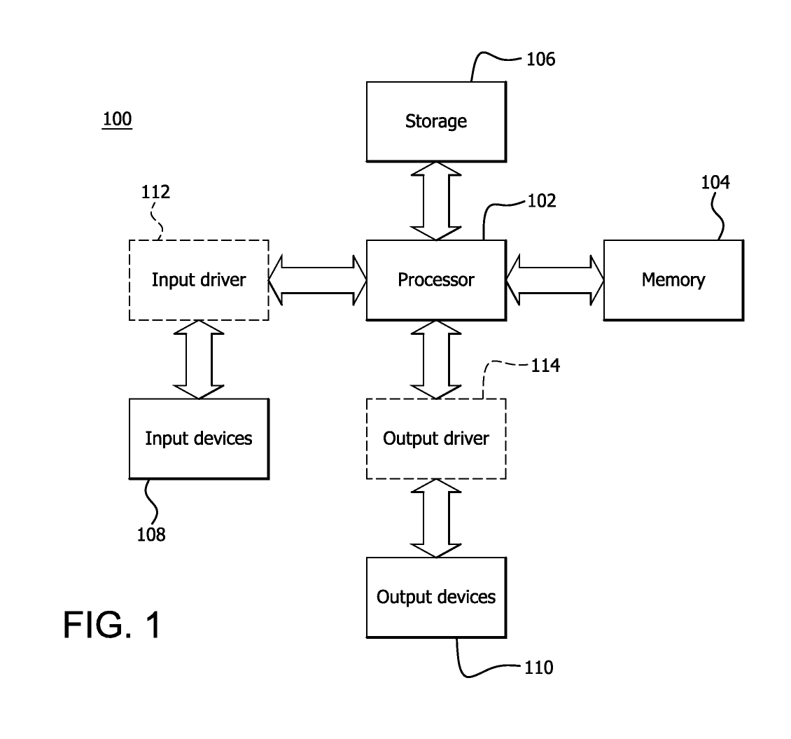

FIG. 1 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner is the input driver 112 and the output driver 114 are not present.

To be an acceptable solution to support EH on a GPU, the solution has to (1) allow excepting and non-excepting work items (i.e., threads) to join their execution at each function boundary (due to the GPU hardware limitations), and (2) have minimal performance overhead when no exceptions are thrown, because the CPU zero-cost case described above cannot be achieved on a GPU.

In this approach, a high-level C++ compiler transforms throw clauses and the functions in a try block that may throw exceptions to a sequence of control flows, which compare the exception object type against each candidate exception handler. If there is a match, a branch instruction jumps to the matched handler to handle the thrown exception and then resumes normal execution. The sequence of checking candidate exception handlers traverses enclosing try blocks and their associated exception handlers from inner to outer scopes. If the exception object type is known at the compilation time, the compiler may simplify the control flows and jump directly to the corresponding handler. It is noted that the compiler also has to generate code to destruct live objects local to the scope that is being exited.

Current GPUs are already capable of dealing with thread divergence under arbitrary control flows expressed in FSAIL instructions within a given function. The JIT compiler translates FSAIL branch instructions into predicated code or special native conditional branch and join instructions. Both excepting threads (those threads that throw an exception) and non-excepting threads have to join back together at a function boundary. When execution reaches a function boundary, the execution waits and does not begin to unwind the stack if there are still exceptions to be handled. The execution waits for non-excepting threads to execute and return (i.e., complete execution). If and only if both the excepting threads and the non-excepting threads reach the return point (e.g., the end of the function), both will return back to the caller. This restriction on returning back to the caller is imposed because of the nature of SIMD execution.

When the excepting thread returns and has not found an error handler for the exception, the thread needs to continue to look for an appropriate error handler. The execution flow returns to the caller, and the excepting and non-excepting threads may diverge again. Branches are used to lead the diverging thread forward. To allow an excepting work-item whose exception has not been handled upon a function return to continue looking for a handler instead of executing the normal code paths as the non-excepting work-items, a reserved FSAIL variable “private_b8 hasexceptionhappened” is defined. This variable (referred to generally herein as an “exception flag”) has a global scope but is unique to each work-item, and it is allocated outside of any function. The convention is to set the exception flag as soon as an exception is raised, and reset the exception flag only after the exception is handled. Upon the return from a call, a work-item needs to check the value of the exception flag. If the flag is set, this work-item needs to follow a code path divergent from the non-excepting work-items to continue searching a proper handler. The JIT compiler has to recognize this special variable and map it to a fixed memory location (or possibly a register, as an optimization). Because the C++EH specification does not allow multiple outstanding exceptions in each thread, a single variable is sufficient for each work-item. This provides the appearance of no thread divergence across function boundaries.

The costs of checking exception types against exception handlers and performing control flow transfers are incurred only when an exception is thrown, except for the case that the exception flag is checked upon a function return even if no exceptions have been thrown. This is an artifact of not allowing thread divergence across function boundaries. This comparison is an unavoidable but acceptable overhead, because functions may continue to be aggressively inlined for GPU offload functions. If a C++ high-level compiler is informed through a compilation option that no exceptions are thrown in an application, it does not need to generate the code to check the exception flag.

An implementation in a C++ high-level compiler is described the following pseudo code. The C++ code is processed, and additional structure and mechanisms are added to the code to perform the EH on the GPU. The resulting code follows the same semantics of the original source code.

This implementation uses a global variable (the exception flag) to indicate that any thread has thrown an exception. In the examples below, this variable is referred to as hasexceptionhappened. It is noted that a person skilled in the art could devise other ways of tracking whether any thread has thrown an exception (e.g., an exception raised indicator), without altering the overall operation of the method. Once an appropriate exception handler has been found, the exception handler resets this variable to indicate that the exception has been handled, and the thread can resume normal execution upon returning to the calling function. The variable will remain set (as indicating that there is an exception that has not yet been handled) upon the excepting thread returning to the caller, unless the exception handler routine resets it.

// Perform this during the start of each work-item.
Allocate hasexceptionhappened and initialize it to False;
ProcessExceptionHandling(Function currFunc)
{
Visit all try blocks in currFunc in a lexical and outer-to-inner order {

currTry = the current try block;
Add a label, join_label, following the currTry block;
For each catch clause in currTry {

currCatch = the current catch clause;
Create a label attached to the beginning of currCatch;
Append an instruction to reset hasexceptionhappened in currCatch;
Append an unconditional jump to join_label in currCatch;

}
For each throw or function call in currTry {

currInst = the current instruction, i.e. a throw or a call;
foundHandler = False;
Create a landing pad block, landing_pad;
if (currInst is a throw) {

Replace the throw with the landing_pad block;
Capture the exception object in exception_object;
Append an instruction to set hasexceptionhappened in

landing_pad;

} else if (currInst is a call) {

Insert a conditional branch after currInst based on a True

value of Hasexceptionhappened and the branch target is landing_pad;

// The exception object is already in exception_object;

}
Visit the enclosing try blocks of currTry following the inner-to-outer

order {

currScopeTry = the try block of the current scope;
Append destructor calls in landing_pad for currently live

objects local to currScopeTry;

For each catch clause for currScopeTry {

currCatch = the current catch clause;
if (the type of exception_object is known && the type

equals the type of currCatch) {

Append a jump to the label of currCatch in

landing_pad;

foundHandler = True;

} else {

Append a conditional branch in landing_pad by

comparing the type in exception_object against the type in currCatch and branch on a
True condition to the label of currCatch;

if (currCatch is a catch-all case) {

foundHandler = True;

}

}
if (foundHandler == True) break;

}
if (foundHandler == True) { break; }
else {

Create a block, new_landing_pad;
Append a jump in landing_pad to new_landing_pad;
landing_pad = new_landing_pad;

}

}
if (foundHandler == False) {

// The exception may have to go to the callers to find

handlers.

Append destructor calls in landing_pad for the currently live

objects local to currFunc;

Append a return instruction to landing_pad;

}

}

}
Visit all functions in currFunc but not enclosed in any try block {

currInst = the current call instruction;
Create a landing pad block, landing_pad;
Insert a conditional branch after currInst based on a True value of

Hasexceptionhappened and the branch target is landing_pad;

Append destructor calls in landing_pad for the currently live objects local

to currFunc;

Append a return instruction to landing_pad;

}
}

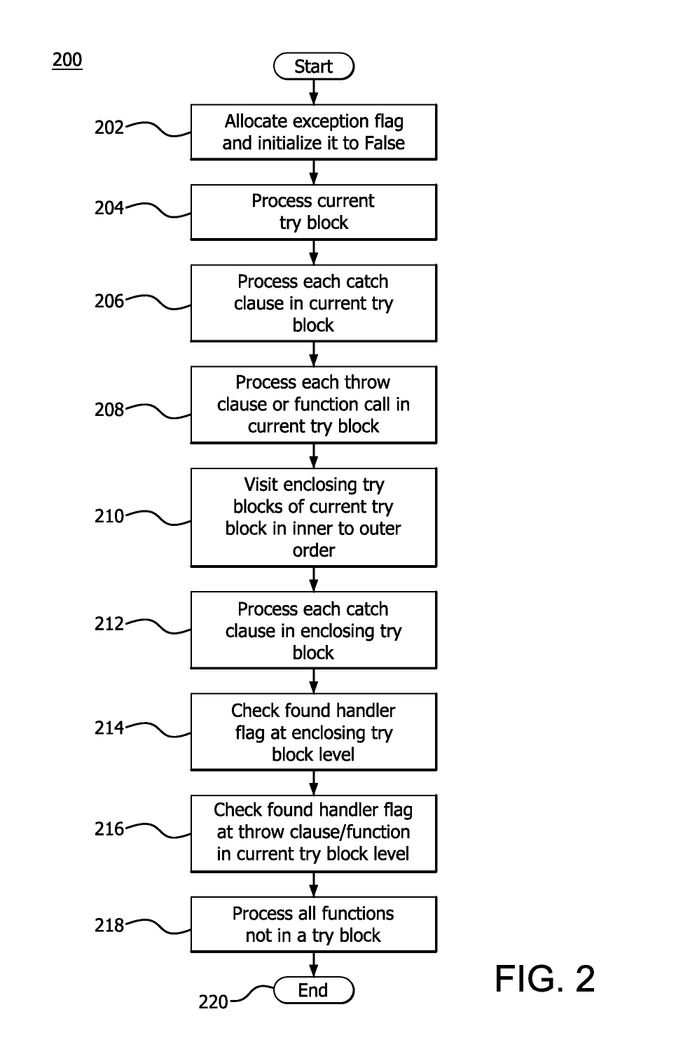

FIG. 2 is a flowchart of a method 200 for processing C++ code to implement exception handling on a GPU. The method 200 is performed for each function block in the program code and shows an overview of the code processing; several procedures will be further described in additional detail below. The method 200 begins by allocating an exception flag and initializing it to false (step 202).

The method 200 processes all of the try blocks in the current function in a lexical and outer to inner order. A current try block is selected and processed (step 204). The try block processing includes adding a “join label” at the end of the current try block, and is used as an exit point for the current try block.

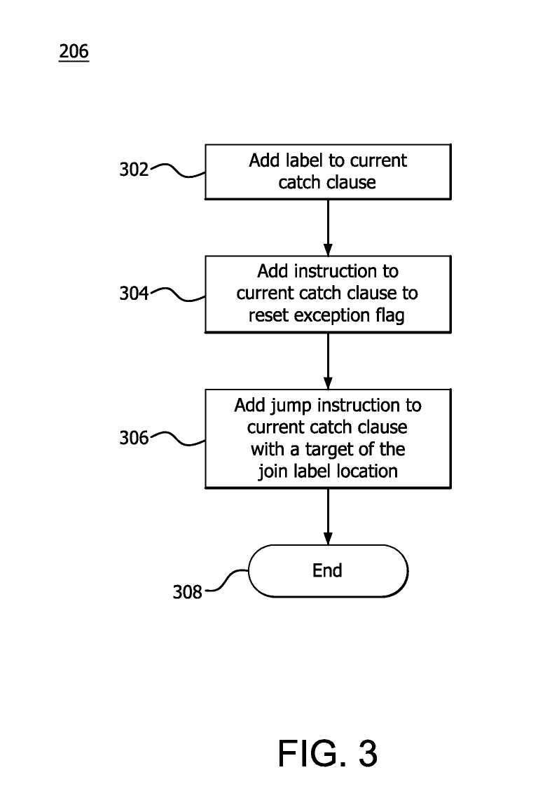

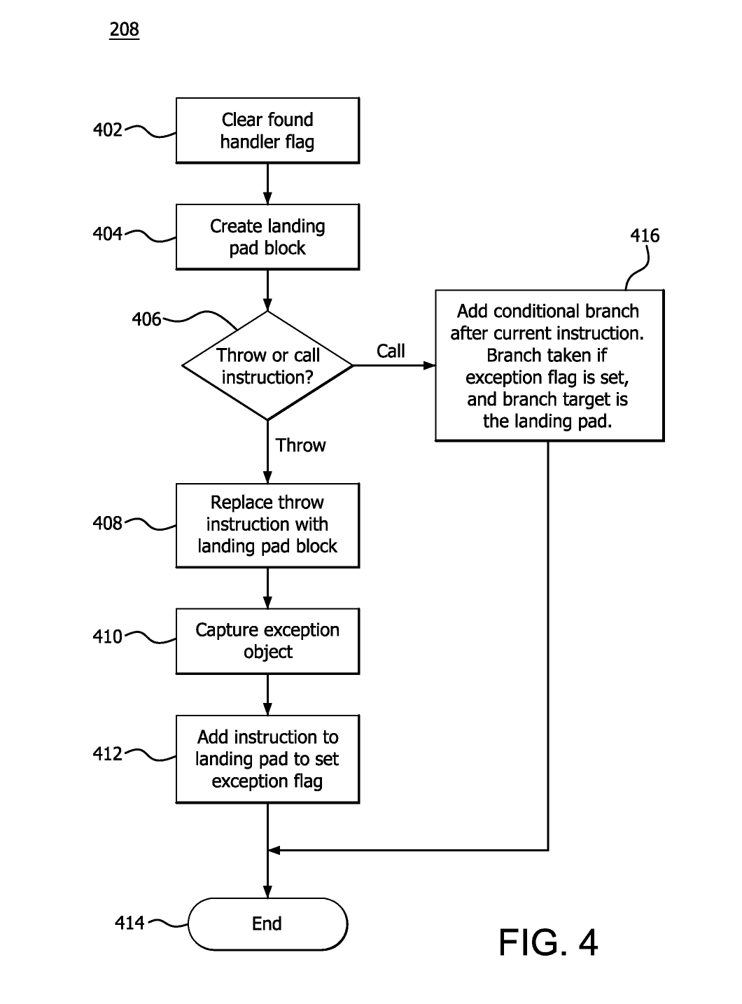

Each catch clause in the current try block is processed (step 206). This catch clause processing will be described in greater detail in connection with FIG. 3. Each throw clause or function call in the current try block is processed (step 208). This throw clause and function call processing will be described in greater detail in connection with FIG. 4.

As part of processing each throw clause or function call in the current try block, any other try blocks contained within the current try block (referred to as “enclosing try blocks”) are visited in an inner to outer order (step 210). Destructor calls are added to a landing pad block associated with the enclosing try block for currently live objects that are local to the enclosing try block being evaluated.

The landing pads as used herein follow the concept from the CPU side, in that they are convenient locations for common branches to go to if an appropriate exception handler for the exception object type cannot be found. The landing pad acts as a placeholder to call a destructor for live objects that are local to the current function (because the function is being exited, this is part of the necessary clean up). After this cleaning up of the function is complete, the next “outer” enclosing scope is checked for an appropriate exception handler for the exception object type. If an appropriate exception handler is not found as the code moves back up the layers of function calls, the landing pads are used at each layer where an appropriate exception handler is not found.

When performing EH on a CPU, the branches are not explicit (e.g., not directly to a landing pad). In a CPU implementation, an EH routine performs a lookup in a table, and if there is no match in the table, then the landing pad is used. This implementation is waiting to pay a high penalty when an exception happens, meaning that the implementation is structured such that when there is no exception (which is the normal case), the code executes efficiently, without table lookups, etc. But in a GPU implementation, the execution flow is streamlined in using conditional branches, not using indirect branches through lookup tables, to jump to the landing pads. This is due to the nature of the SIMD design of a GPU, in which the efficiencies realized in a CPU implementation cannot be utilized in a GPU implementation.

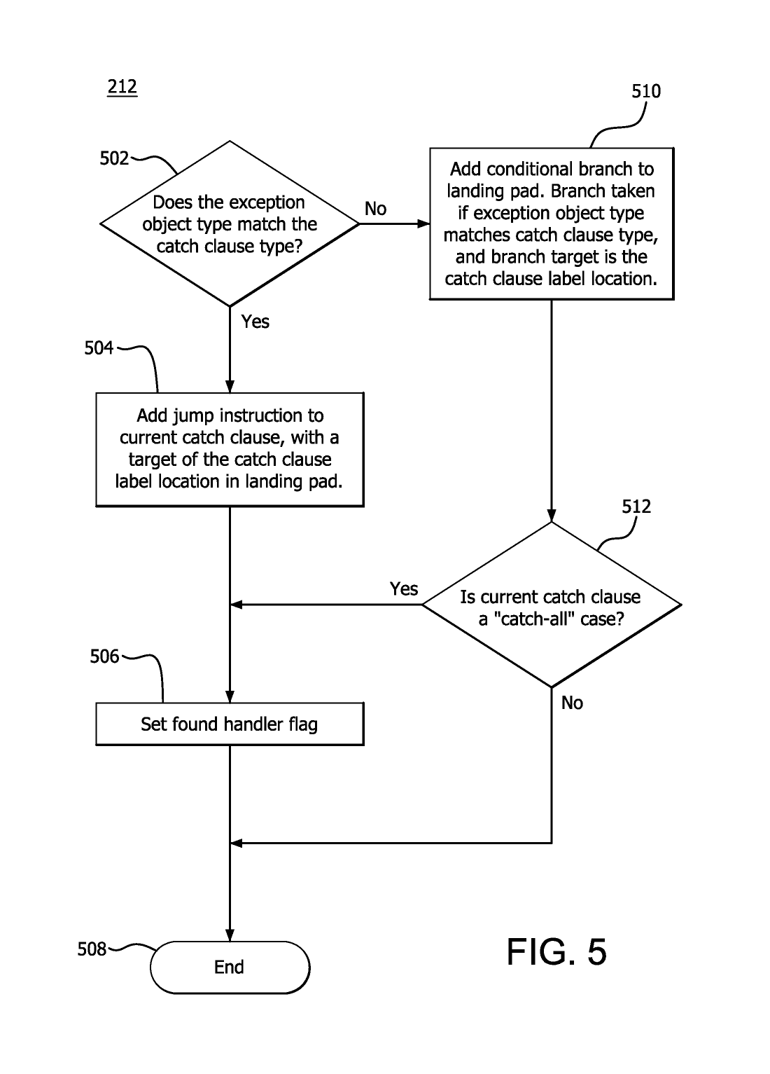

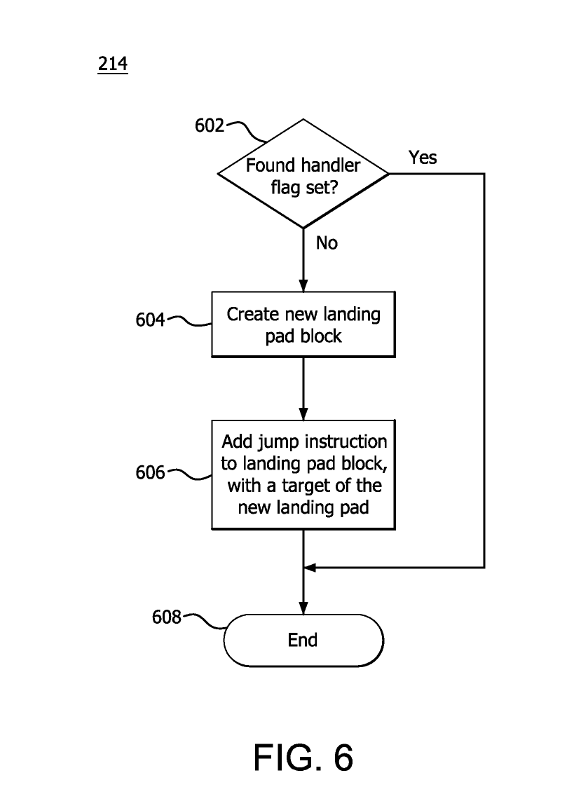

Referring back to FIG. 2, each catch clause within the enclosing try block is processed (step 212). This catch clause processing will be described in greater detail in FIG. 5. After each catch clause in the enclosing try block has been processed, a found handler flag at the enclosing try block level is checked (step 214). The found handler flag indicates whether an exception handler for the thrown exception has been found. This process will be described in greater detail in FIG. 6.

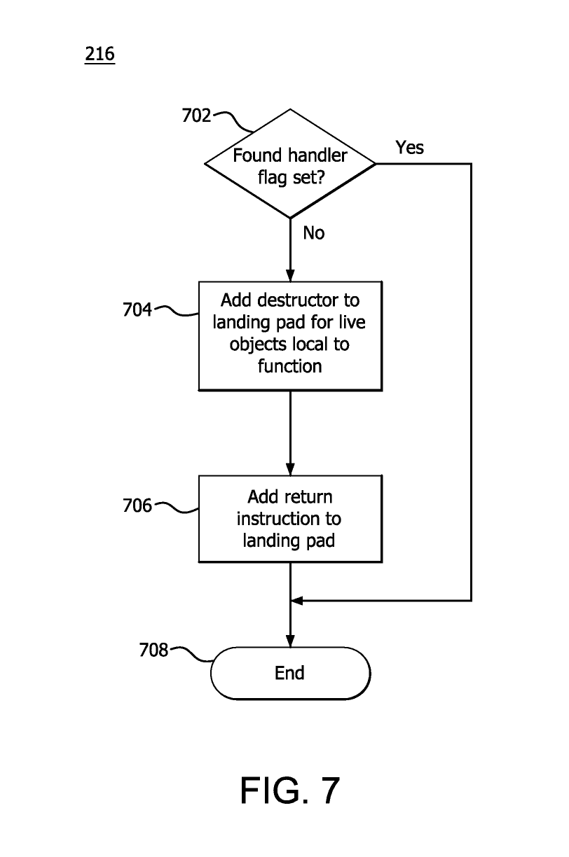

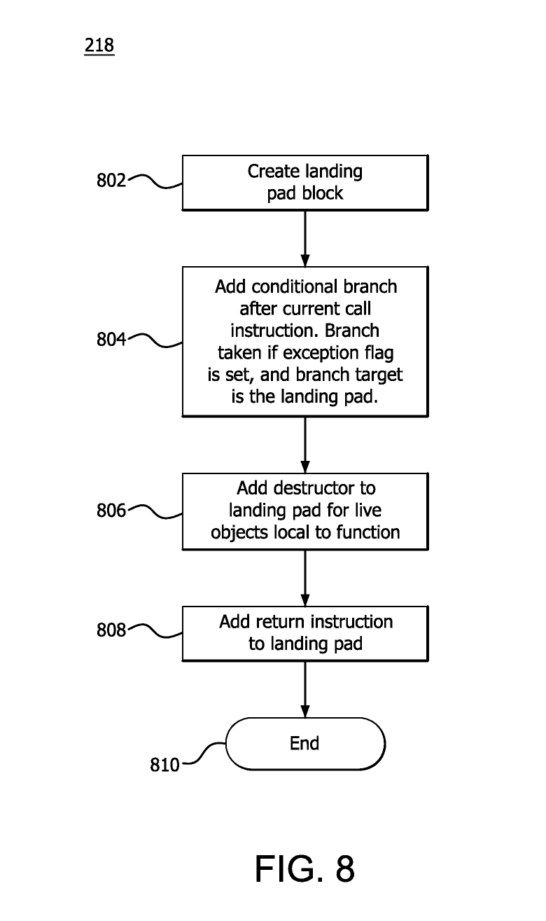

After visiting all of the enclosing try blocks within the current try block, the found handler flag at the current try block level is checked (step 216). This process will be described in greater detail in FIG. 7. All other functions within the current try block that are not enclosed in any other try block are processed (step 218) and the method terminates (step 220). Processing the other functions within the current try block will be described in greater detail in FIG. 8.

The method 200 only imposes a low performance overhead on non-excepting execution paths. A small amount of overhead is added after each function return to check for excepting threads, but does not add any other execution overhead if no exceptions occur. While this approach adds a slight overhead compared to the “zero-cost” approach on CPUs, it is more efficient compared to previous approaches like using setjmp/longjmp instructions.

The method 200 does not rely on any handshake between the FSAIL instructions and the exception tables generated by a high-level compiler as in the CPU “zero-cost” approach. Because the JIT compiler may expand the FSAIL instructions and alter the instruction order, such a handshake is challenging to maintain correctly in the GPU tool chains, where the JIT compiler is an essential component.

FIG. 3 is a flowchart of a method for processing a catch clause in a current try clause block (step 206 in FIG. 2). An identifier label is added to the current catch clause (step 302). In the current catch clause, an instruction is added to reset the exception flag (step 304) and an instruction is added to jump to the join label location, to exit the try block (step 306). The processing of the current catch clause then terminates (step 308).

FIG. 4 is a flowchart of a method for processing a throw clause or a function call in a current try clause block (step 208 in FIG. 2). The found handler flag is cleared (step 402). A landing pad block is created (step 404) and the instruction is evaluated to determine whether it is a throw or a call (step 406). If the instruction is a throw, then the throw instruction is replaced with the landing pad block (step 408). The exception object is captured (step 410), an instruction is added to the landing pad to set the exception flag (step 412), and the processing of the throw instruction terminates (step 414). If the instruction being evaluated is a call (step 406), then a conditional branch instruction is added after the call instruction (step 416). This conditional branch will be taken if the exception flag is set, with a branch target of the landing pad. The processing of the call instruction then terminates (step 414).

FIG. 5 is a flowchart of a method for processing a catch clause in an enclosing try block (step 212 in FIG. 2). A determination is made whether the exception object type matches the catch clause type (step 502). If the exception object type and the catch clause type match, then a jump instruction is added to the current catch clause (step 504). The target of the jump instruction is the catch clause label location in the landing pad. The found handler flag is set (step 506) and the processing of the catch clause terminates (step 508). If the exception object type does not match the catch clause type (step 502), a conditional branch instruction is added to the landing pad (step 510). This conditional branch is taken if the exception object type matches the catch clause type, and the branch target is the catch clause label location in the landing pad. A determination is made whether the current catch clause is a “catch-all” case (step 512). If the current catch clause is a “catch-all” case, then the found handler flag is set (step 506) and the processing of the catch clause terminates (step 508). If the current catch clause is not a “catch-all” case (step 512), then the processing of the catch clause terminates (step 508).

FIG. 6 is a flowchart of a method for processing a found handler flag in an enclosing try block (step 214 in FIG. 2). A determination is made whether the found handler flag is set (step 602). If the found handler flag is not set, then a new landing pad block is created (step 604). A jump instruction is added to the current landing pad block, and the jump destination is the new landing pad (step 606). The processing of the found handler flag then terminates (step 608). If the found handler flag is set (step 602), then processing of the found handler flag terminates (step 608).

FIG. 7 is a flowchart of a method for processing a found handler flag in a current try block (step 216 in FIG. 2). A determination is made whether the found handler flag is set (step 702). If the found handler flag is not set, then a destructor for live objects that are local to the function is added to the landing pad (step 704). A return instruction is added to the landing pad (step 706), and processing of the found handler flag terminates (step 708). If the found handler flag is set (step 702), then processing of the found handler flag terminates (step 708).

FIG. 8 is a flowchart of a method for processing a function located outside a try block (step 218 of FIG. 2). A landing pad block is created (step 802). A conditional branch is added after the current call instruction (step 804). This conditional branch is taken if the exception flag is set, with the branch target being the landing pad. A destructor for live objects that are local to the function is added to the landing pad (step 806). A return instruction is added to the landing pad (step 808), and processing of the function terminates (step 810).

The following is an example which applies this approach in translating the C++ EH constructs into control flows on the current GPU architectures.

try { // try 1

try { // try 2

if (..) throw e1;
..

}
catch (t1) {

// handler 1

}
catch (t2) {

//handler 2

}
try { // try 3

if (..) throw e2;
..
if (..) foo( );
..

}
catch (t3) {

// handler 3

}
catch (t4) {

// handler 4

}

...
}
catch (t5) {

// handler 5

}
catch (t6) {

// handler 6

}
...
return;
The transformed pseudo code will look like the following.
try1: {
...
try2: {

if (..) {

// throw e1;
Hasexceptionhappened = True;
Calling destructors for live objects local to try2;
if ( e1.type == t1 ) { goto catch_t1; }
else If ( e1.type == t2 ) { goto catch_t2; }
else { goto land_pad_e1_try1; }

}
...

}
join_try2:
try3: {

if (..) { // throw e2;

Hasexceptionhappened = True;
Calling destructors for live objects local to try3;
if ( e2.type == t3 ) { goto catch_t3; }
else If ( e2.type == t4 ) { goto catch_t4; }
else { goto land_pad_e2_try1; }

}

...

if (..) { foo( );

if (Hasexceptionhappened) {

goto landing_pad_foo_try3;

}

}

}
join_try3:
}
join_try1:
...
return;
catch_t1:

// handler 1
Hasexceptionhappened = False;
goto join_try2;

catch_t2:

// handler2
Hasexceptionhappened = False;
goto join_try2;

land_pad_e1_try1:

Calling destructors for live objects local to try1;
if ( e1.type == t5 ) { goto catch_t5; }
else if ( e1.type == t6 ) { goto catch_t6; }
else { goto land_pad_e1_rtn; }

land_pad_e1_rtn: // Did not find an exception handler in the current
function

Calling destructors for live objects local to the current function;
return;

catch_t3:

// handler3
Hasexceptionhappened = False;
goto join_try3;

catch_t4:

// handler4
Hasexceptionhappened = False;
goto join_try3;

land_pad_e2_try1:

Calling destructors for live objects local to try1;
if ( e2.type == t5 ) { goto catch_t5; }
else if ( e2.type == t6 ) { goto catch_t6; }
else { goto land_pad_e2_rtn; }

land_pad_e2_rtn: // Did not find an exception handler in the current
function

Calling destructors for live objects local to the current function;
return;

landing_pad_foo_try3:

Calling destructors for live objects local to try3 for leaving try3;
if ( exception_object.type == t3 ) { goto catch_t3; }
else if (exception_object.type == t4 ) { goto catch_t4; }
else { goto land_pad_foo_try1; }

land_pad_foo_try1:

Calling destructors for live objects local to try1;
if (exception_object.type == t5 ) { goto catch_t5; }
else if (exception_object.type == t6 ) { goto catch_t6; }
else { goto land_pad_foo_rtn; }

catch_t5:

// handler5
Hasexceptionhappened = False;
goto join_try1;

catch_t6:

// handler6
Hasexceptionhappened = False;
goto join_try1;

land_pad_foo_rtn: // Did not find an exception handler in the current
function

Calling destructors for live objects local to the current function;
return;

// end of the transformed example

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the present invention.

The methods or flow charts provided herein may be implemented in a computer program, software, or firmware incorporated in a non-transitory computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A method for processing a source code function by a compiler for execution on a graphics processing unit (GPU), the source code function including an exception handling structure, the method comprising:
converting an exception raising block in the source code function into a first control flow for execution on the GPU, wherein the first control flow includes:
setting an exception raised indicator; and
finding an exception handler to process the raised exception; and
converting an exception handler block in the source code function into a second control flow for execution on the GPU, wherein the second control flow includes:
clearing the exception raised indicator; and
processing the exception.

2. The method according to claim 1, wherein the exception raised indicator remains set until an appropriate exception handler is found.

3. The method according to claim 1, wherein the finding includes:
comparing an exception object type against one or more candidate exception handlers in a current lexical scope;
jumping to the exception handler if the exception object type matches an exception handler type; and
jumping to a landing pad block in a lexical scope one layer outside the current lexical scope if no matching exception handler is found.

4. The method according to claim 3, wherein the landing pad block includes:
calling destructors for objects local to the current lexical scope;
comparing the exception object type against each candidate exception handler in the current lexical scope;
jumping to the exception handler if the exception object type matches an exception handler type; and
jumping to a return function in the current lexical scope if no matching exception handler is found.

5. The method according to claim 4, wherein the return function includes:
calling destructors for objects local to the current function; and
returning to a calling function.

6. The method according to claim 1, wherein the first control flow further includes:
calling destructors for objects local to a current lexical scope.

7. The method according to claim 1, wherein the second control flow further includes:
jumping to a location in the function after the exception raising block.

8. A system, comprising:
a processor; and
a compiler executed by the processor to perform operations to process a source code function for execution on a graphics processing unit (GPU, the operations including:
converting an exception raising block in the source code function into a first control flow for execution on the GPU, wherein the first control flow includes:
setting an exception raised indicator; and
finding an exception handler to process the raised exception; and
converting an exception handler block in the source code function into a second control flow for execution on the GPU, wherein the second control flow includes:
clearing the exception raised indicator; and
processing the exception.

9. The system according to claim 8, wherein the exception raised indicator remains set until an appropriate exception handler is found.

10. The system according to claim 8, wherein the finding includes:
comparing an exception object type against one or more candidate exception handlers in a current lexical scope;
jumping to the exception handler if the exception object type matches an exception handler type; and
jumping to a landing pad block in a lexical scope one layer outside the current lexical scope if no matching exception handler is found.

11. The system according to claim 10, wherein the landing pad block includes:
calling destructors for objects local to the current lexical scope;
comparing the exception object type against each candidate exception handler in the current lexical scope;
jumping to the exception handler if the exception object type matches an exception handler type; and
jumping to a return function in the current lexical scope if no matching exception handler is found.

12. The system according to claim 11, wherein the return function includes:
calling destructors for objects local to the current function; and
returning to a calling function.

13. The system according to claim 8, wherein the first control flow further includes:
calling destructors for objects local to a current lexical scope.

14. The system according to claim 8, wherein the second control flow further includes:
jumping to a location in the function after the exception raising block.

15. A non-transitory computer-readable storage medium storing a set of instructions for execution by a computer to process a source code function for execution on a graphics processing unit (GPU), the source code function including an exception handling structure, the set of instructions comprising:
a first converting code segment for converting an exception raising block in the source code function into a first control flow for execution on the GPU, wherein the first control flow includes:
setting an exception raised indicator; and
finding an exception handler to process the raised exception; and
a second converting code segment for converting an exception handler block in the source code function into a second control flow for execution on the GPU, wherein the second control flow includes:
clearing the exception raised indicator; and
processing the exception.

16. The non-transitory computer-readable storage medium according to claim 15, wherein the exception raised indicator remains set until an appropriate exception handler is found.

17. The non-transitory computer-readable storage medium according to claim 15, wherein the finding includes:
comparing an exception object type against one or more candidate exception handlers in a current lexical scope;
jumping to the exception handler if the exception object type matches an exception handler type; and
jumping to a landing pad block in a lexical scope one layer outside the current lexical scope if no matching exception handler is found.

18. The non-transitory computer-readable storage medium according to claim 17, wherein the landing pad block includes:
calling destructors for objects local to the current lexical scope;
comparing the exception object type against each candidate exception handler in the current lexical scope;
jumping to the exception handler if the exception object type matches an exception handler type; and
jumping to a return function in the current lexical scope if no matching exception handler is found.

19. The non-transitory computer-readable storage medium according to claim 18, wherein the return function includes:
calling destructors for objects local to the current function; and
returning to a calling function.

20. The non-transitory computer-readable storage medium according to claim 15, wherein the first control flow further includes:
calling destructors for objects local to a current lexical scope.

21. The non-transitory computer-readable storage medium according to claim 15, wherein the second control flow further includes:
jumping to a location in the function after the exception raising block.

22. The non-transitory computer-readable storage medium of claim 15, wherein the instructions are hardware description language (HDL) instructions used for the manufacture of a device.
